(19) United States
(12) Patent Application Publication
(10) Pub. No.: US 2004/0088246 A1
(43) Pub. Date: May 6, 2004

(54) System and method for loan application generation

(75) Inventors: Keith J. Jepsen, New York, NY (US); Steven Harkola, Fairport, NY (US)

Correspondence Address: FOLEY & LARDNER, 777 EAST WISCONSIN AVENUE, SUITE 3800, MILWAUKEE, WI, 53202-5308, US

(73) Assignee: Global Student Loan Corp.

(21) Appl. No.: 10/288,198

(22) Filed: Nov. 5, 2002

(51) Int. Cl. G06F 17/60

(52) U.S. Cl. 705/38

(57) ABSTRACT

A system and method for facilitating an application between an applicant and a plurality of partners is disclosed. The system may include a processing unit and a memory portion in communication with the processing unit having information stored therein to configure the processing unit to receive a plurality of partner defined question sets, to receive first data from the applicant, and to generate an application for the applicant. At least one partner is selected from the plurality of partners in response to the first data received from the applicant. The application includes at least one question from the partner defined question set of the selected partner.

### BACKGROUND OF THE INVENTION

The present invention relates generally to facilitating an application process. More particularly, exemplary embodiments of the present invention relate to systems and methods for generating various applications (such as loan applications, credit card applications, consumer loan applications, school admission applications, employment applications, or a variety of other applications) and facilitating the transfer and use of the applications over a communication network, such as the Internet.

With respect to student loan applications, demand for worldwide student loan programs to facilitate higher level education in the United States has been rapidly expanding. Coordinating loans for multiple students from numerous countries increases the complexity of student loan programs. Each country that the student comes from (e.g., country partners) may impose different requirements for generation of student loans. Such loan programs impose workflows, data collection and processing requirements unique to each country partner within an international exchange community.

Currently, international student loans are processed manually and require a U.S. co-signer if U.S. based financial companies are utilized. Lead time and overhead costs associated with program implementation for present systems can be costly. Currently, there is no market with an exchange that supports foreign financial institutions supplying capital for foreign students studying in the U.S. or in many cases, for foreign students studying in their home country.

Thus, there is a need to provide a system and method to allow for the creation of a dynamic application for a variety of different uses that would include both standard, commonly asked questions and “dynamic” or specific questions that one or more entities associated with the application may desire. Further, there is a need to provide for an application process within the framework of an Application Service Provider (ASP) hosted environment in order to connect hundreds of U.S. and foreign based schools supporting student loan programs with various student populations and financial partners. Further, there is a need to minimize total cost of ownership for each partner by using a centralized service while maximizing work flow process, data collection, loan certification and loan approval configuration and change. Further, there is a need to accelerate the expansion of student loan programs world wide while addressing the unique workflows, data collection and processing requirements unique to each partner. Further, there is a need to cut lead time and overhead costs associated with international student loan program implementation, day to day production processing of student loan applications, loan origination, funds disbursement and loan repayment servicing. Further, there is a need to allow each partner to assume greater autonomy as well as take control of their own processes within context of an Internet exchange environment.

### SUMMARY OF THE INVENTION

One embodiment of the invention relates to a system for facilitating a loan between a borrower and a plurality of partners. The system includes a processing unit and a memory portion in communication with the processing unit having information stored therein to configure the processing unit to receive a plurality of partner defined question sets, pre-qualify borrowers, receive first data from the borrower, and generate a loan application for the borrower. At least one school partner and one lending institution partner is selected from the plurality of partners in response to the first data received from the borrower. The loan application includes at least one question from the partner defined question set of the selected partner or partners.

Another embodiment of the invention relates to a method for dynamically generating a loan application using questions sets from each partner type. The method includes providing a first registration template for a plurality of lending partners and a second registration template for school partners. The method further includes receiving lending partner registration data from the plurality of lending partners and receiving school partner registration data from a plurality of school partners. The lending partner registration data comprises at least one partner specific question from at least one of the plurality of lending partners. The school partner registration data comprises at least one partner specific question from at least one of the plurality of school partners. The method further includes providing a third registration template for a student borrower, and generating a dynamic loan application for completion by the student borrower. The method further includes the ability to utilize partner specific pre-qualification questions used to screen student applicants, and the ability to apply business rules, revisions to questions, multilingual descriptions, help text for assistance, and error messages. The dynamic loan application includes at least one partner specific question.

A further embodiment of the invention relates to a method for dynamically generating a student loan application. The method includes concatenation of a plurality of partner defined question sets based on student selection of their preferred school and lending institution to generate a loan application for the borrower. At least one partner is selected from the plurality of partners in response to the first data received from the borrower. The loan application includes at least one question from the partner defined question set of the selected partner.

A further embodiment of the invention relates to a method for generating an application for an applicant. The method includes providing a first registration template for a plurality of partners, and receiving partner registration data from the plurality of partners. The partner registration data comprises at least one question determined by least one partner of the plurality of partners. The method further includes providing a second registration template for completion by the applicant, and generating a dynamic application for completion by the applicant. The dynamic application further comprises the at least one partner determined question.

A further embodiment of the invention relates to a method for generating an application for an applicant. The method includes receiving a plurality of partner defined question sets, receiving first data from the applicant, and generating an application for the applicant. At least one partner is selected from the plurality of partners in response to the first data received from the applicant. The application includes at least one question from the partner defined question set of the selected partner.

In a further embodiment, once the student borrower and optional co-signer completes entry of all required loan application questions, a further embodiment provides a work flow engine which generates school certification and lending institution approval work queues to facilitate school verification of attendance and lender credit scoring evaluation. A further embodiment provides for a timer module that reduces the lead time associated with moving the student loan application through the approval cycle in order to ensure that the schools receives funding disbursement in a timely manner. A further embodiment provides for communications between the student borrower, co-signer, school, lending institution and any other partner associated with a specific loan program implementation including email notifications, portal alerts and chronological notes associated with one or more steps in the process.

### BRIEF DESCRIPTION OF THE DRAWINGS

FIG. 1 is a general schematic representation of an application system;

FIG. 2 is a general functional block diagram of an exemplary embodiment of the application system;

FIG. 3 is a general functional block diagram of a registration process for the application system; and

FIG. 4 is a general functional block diagram of a question set administration process for the application system.

### DETAILED DESCRIPTION OF THE PREFERRED EMBODIMENTS

Systems and methods for facilitating an application process are disclosed. The systems and methods disclosed provide for generation of one or more applications for completion by an applicant. The systems and methods disclosed further facilitate the transfer and use of the applications for various entities involved with the application process. Transferring and using the applications may be done over communications networks such as the Internet.

Various processes may require one or more applications be completed (such as loan applications, credit card applications, consumer loans, school admission applications, employment applications, etc.). These processes may require one or more applications (such as application forms) to be completed in order to initiate, facilitate, or complete the process. It may be desirable to generate an application for an applicant that is associated with the process. According to various exemplary embodiments, the application may generated to include standard or commonly asked questions as well as non-standard questions particular to one or more parties (or partners) associated with the process. The systems and methods disclosed allow for a “dynamic” application to be generated based on a first set of standard questions to be included in the application, as well as a second set of questions tailored to individual parties involved with the application. According to one exemplary embodiment discussed below, the application is a student loan application for completion by a borrower (such as student borrowers). The application may include questions specified or requested by one or more partners involved with the loan application process (such as schools, lenders, guarantors, etc.). It should be noted at the outset that although various exemplary embodiments are discussed in the context of student loan applications, the systems and methods may be implemented in a wide variety of uses for a variety of different applications, with a variety of different applicants and partners.

In one embodiment, a computer system is used which has a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

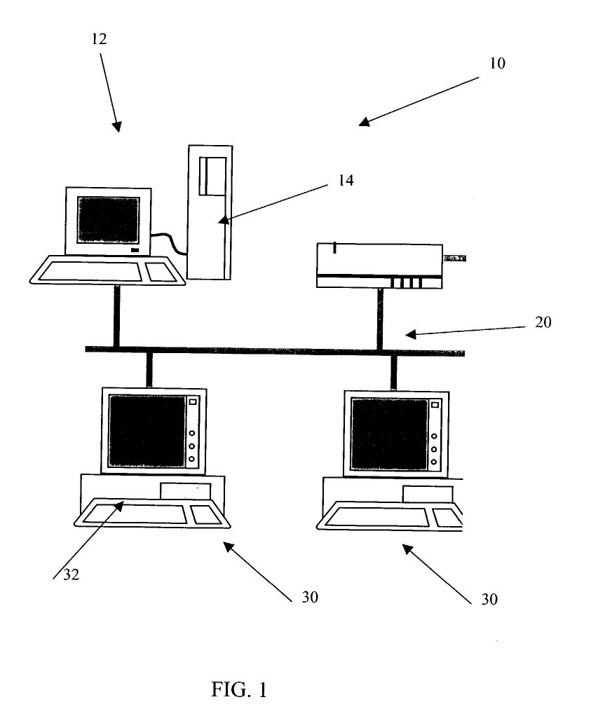

FIG. 1 shows an application system 10 (such as a loan application system). Application system 10 may comprise a server 12, network 20 and a portal 30. Network 20 connects server 12 and one or more portals 30. In an exemplary embodiment, network 20 is the Internet, a worldwide network of computer networks that use various protocols to facilitate data transmission and exchange. Network 20 can use a protocol, such as, the TCP/IP network protocol or the DECnet, X.25, and UDP protocols. In alternative embodiments, network 20 is any type of network, such as, a virtual private network (VPN), an Ethernet, or a Netware network. Further, network 20 can include a configuration, such as, a wide area network (WAN) or a local area network (LAN). Network 20 preferably provides communication via Hypertext Markup Language (HTML) web pages. According to an alternative embodiment, the network may provide communication via extensible markup language (XML), etc.

Generally, application system 10 can be implemented using computer server 12 configured by software 14 running on server 12. According to various alternative embodiments, software may be run on a number of different locations, including on the local portal, one or more servers in communication with each other, etc.

Server 12 may have a central processing unit (CPU 14) that executes sequences of instructions (e.g., software) contained in a memory to perform steps which are described below. Preferably, server 12 includes read/write memory, such as, disc drives and other storage.

A user (e.g., borrower, partner, system administrator, applicant, etc.) may access loan application system 10 via a web page which may be conveyed to the user at portal 30. Portal 30 may comprise a computer system 32. Computer system 32 can be any type of computing device, including work stations, laptops, notebooks, personal digital assistants (PDAs), cell phones, beepers, or other equipment capable of communication with network 20. In another embodiment, loan application system 10 can be accessed via telephones, such as, a cell phone or a standard telephone. Other user interface platforms may also be provided for using loan application system 10. Such user interface platforms include, for example, WAP (wireless application protocol) and web interfaces.

Advantageously, application system 10 provides a system that may be used by one or more applicants (such as borrowers) to facilitate their applications, requests, and transactions. According to a particularly preferred embodiment, an applicant may use application system 10 in order to complete one or more loan applications (e.g. student loan applications) and provide all necessary information to ultimately receive disbursed loan amounts. Application system 10 also provides a system that may be used by one or more partners to receive loan applications, access data contained in the applications, and to act accordingly after receiving that data and applications. According to an exemplary embodiment, application system 10 provides an interactive or “online” environment in which all parties involved with the processing of applications may access and use in order to facilitate and/or process the applications.

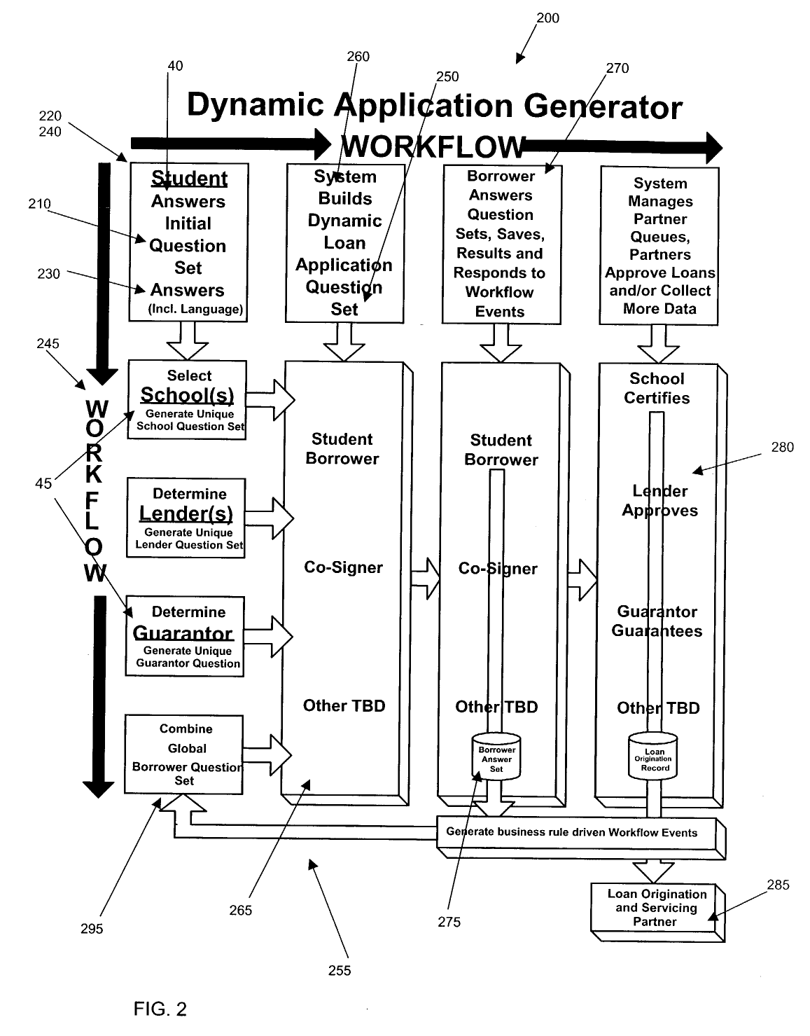

FIG. 2 illustrates a general functional block diagram 200 of application system 10 in accordance with another exemplary embodiment. According to one particularly preferred embodiment, application system 10 is a loan application system that may be used in the context of providing educational loans (such as student loans). According to other alternative embodiments, the application system may be used in the context of providing a wide range of products or faciliting other process, such as credit card applications, consumer loans, school admission applications, employment applications, other loan applications, mortgage lending, automotive lending, or other application processes needing qualifying criteria for a product set, etc. According to a particularly preferred embodiment, the entire application process (e.g., from generating and completing a loan application to originating and servicing the loan, from generating and completing a credit card application to issuing the credit card, etc.) may be done using system 10.

In the context of student loan applications, a first question set 210 may be presented to borrower 40 (e.g., student borrower) (step 220). First question set 210 may include information relating to borrower 40 such as country of citizenship, state, region, province, education type, loan amount requested, enrollment period, etc. According to a particularly preferred embodiment, first question set 210 may be presented to borrower 40 as a series of web pages having fields to be completed by borrower 40. Alternatively, the first question set may be presented as a document, an e-mailed document, a pre-filled application in portable document format (.pdf), e-mail, other electronic media, pre-printed applications, mailed printed applications, etc. having the requisite questions.

Borrower 40 provides responses 230 to first question set 210 (step 240). According to a particularly preferred embodiment, responses 230 may then identify, select, determine, etc. specific partners involved in the loan process (step 245). According to another particularly preferred embodiment, a partner may use one or more responses 230 as criteria to identify potential loan candidates. Such criteria include date of birth, country of citizenship, state, region, province, country of current residence, grade level, undergraduate or graduate status, year in school, type of education (e.g., international student, distance learning, etc.), country the school is established in, requested loan amount, etc. Based on one or more of these criteria, a partner may identify and/or select a borrower or loan candidate for further processing.

According to an alternative embodiment, partners may be “automatically” pre-selected based on the response to first question set 210. For example, one or more of the responses may be used to identify eligible partners (e.g., a country of residence may be used to “filter out” partners such that the eligible partners are from the country of residence). According to another alternative embodiment, partners may be selected with a prioritized selection. Such prioritized selection may be based on various marketing relationships which may dictate the order in which partners appear in pick lists or are automatically selected in a certain order. According to another alternative embodiment, the borrower may be presented with a “pick list” to manually select partners (either initially, or after completing the first question set). This “pick list” may present the partners in a prioritized manner, in alphabetical order, etc.

Once the partners required to originate a student loan are selected, and/or based on the answers to first question set 210, a second question set 250 may be generated for input and/or completion by the applicant or borrower (step 260). According to a particularly preferred embodiment, a “dynamic” second question set 250 (e.g., loan application question set) is built or compiled from a “dynamic application generator.” Second question set 250 may include “standard” questions (i.e. information regularly required to facilitate a loan application process) necessary for the completion of the loan application process. According to a particularly preferred embodiment, standard questions or information may include information shown in APPENDIX A. Furthermore, second question set 250 may include “dynamic,” or non-standard, partner specific questions which vary based on the individual partner as discussed below.

If necessary, other parties required for credit approval (e.g. co-signers, etc.) may be provided with question sets for completion (step 265). According to a particularly preferred embodiment, such question sets may include information shown in APPENDIX B. Application system 10 may accommodate multiple answer set flows from multiple parties. For example, application system 10 may accommodate multiple answer sets from a borrower and from one or more co-signers simultaneously, concurrently, sequentially, or otherwise (see step 255). A separate co-signer process may be used to accommodate a separate credit approval process.

Application system 10 allows for the personalization of the application process. For example, application system 10 allows for borrowers, co-signers, etc. to save their work (e.g., answer sets) for multi-session completion. An applicant may save a partially completed answer set and return to it later for completion.

Additionally, application system 10 may generate additional data collection events required to facilitate partner approvals. Based on an entry or response of a borrower, a work or data collection event may be triggered or generated. For example, in response to a borrower entering a social security number, a request may be generated (by system 10) to a credit reporting agency requesting a credit report for the social security number. As another example, in response to a borrower entering a phone number, system 10 may validate or generate a request for validation with an address look-up service or database in order to verify an address entered by the borrower. One or more data fields presented to a borrower may be workflow enabled, allowing various processes, work events, communications, programs, etc. to be initiated based on the data received. Other processes, including e-mails, work queues, programs, etc. may be initiated.

Second question set 250 is provided to the applicant (shown as borrower 40). Borrower 40 provides responses 260 to second question set 250 (step 270). It should be appreciated that second question set 250 may be dependent on responses 230 to first question set 210. Thus, second question set 250, which is dependent on responses 230, may have different content depending on responses 230. Multiple second question sets may be generated depending on responses 230 or alternatively, on borrower's initial selection of partners.

First responses 230 and second responses 260 may be combined into one loan application or answer set (step 275) which may then be forwarded to one or more of the appropriate partners for action.

Application system 10 may also support unique partner processes such as email generation, incorporation of third party processing (e.g., credit scoring algorithms), work queue generation, special reporting and letter/collateral fulfillment, etc.

Partners 45 may request additional information from borrower 40 by submitting a request for additional information. For example, partners 45 may submit requests for additional information to system 10, which may then be forwarded to borrower or applicant 40. Alternatively, system 10 may be configured to send automated requests based on partner preferences including email, chronological notes or alerts clearly displayed when a student or partner first enters the system, etc.

System 10 may be configured to manage partner work queues. Work queues provide the capability to sort loan applications based on priorities that ensure that the most critical tasks are completed first. Work completion events may be further timed to ensure that lead time standards are adhered to improving processing quality, consistency and efficiency. Additionally, loan applications may be submitted in a variety of preferential orders, batch processes, bulk downloads, etc. providing for unlimited scalability for loan programs world wide.

Once the application contains the necessary or requisite information, partner 45 may then “approve” the application (step 280). Types or form of approval can vary with the partner. For example, a school partner may approve the loan application by certifying the data of borrower 40. A lender may approve the loan application by approving the funding of the loan. A guarantor may approve the loan application by guaranteeing a loan. A credit card company may issue the credit card, etc.

According to a particularly preferred embodiment, once the necessary approvals have been received, approved loan application (e.g., a loan origination transmission or loan origination record) is sent to a loan origination and servicing partner who will transfer the funds to the borrower and service the loan (step 285). The loan origination and servicing partner may further complete any other event required to initiate loan funds transfer and disbursement.

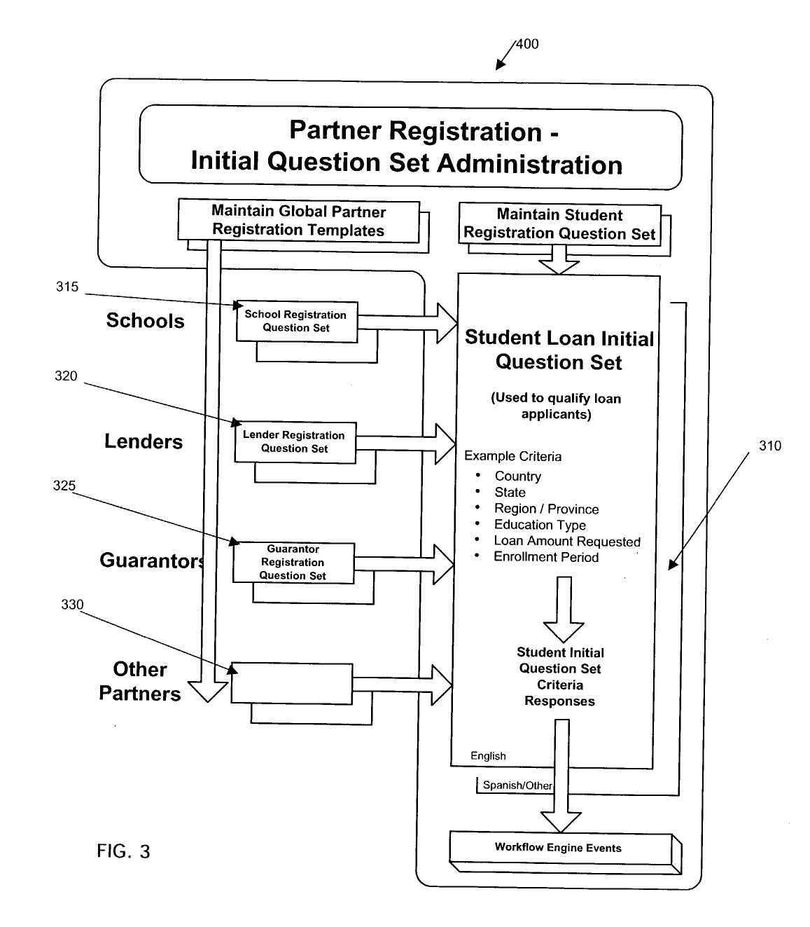

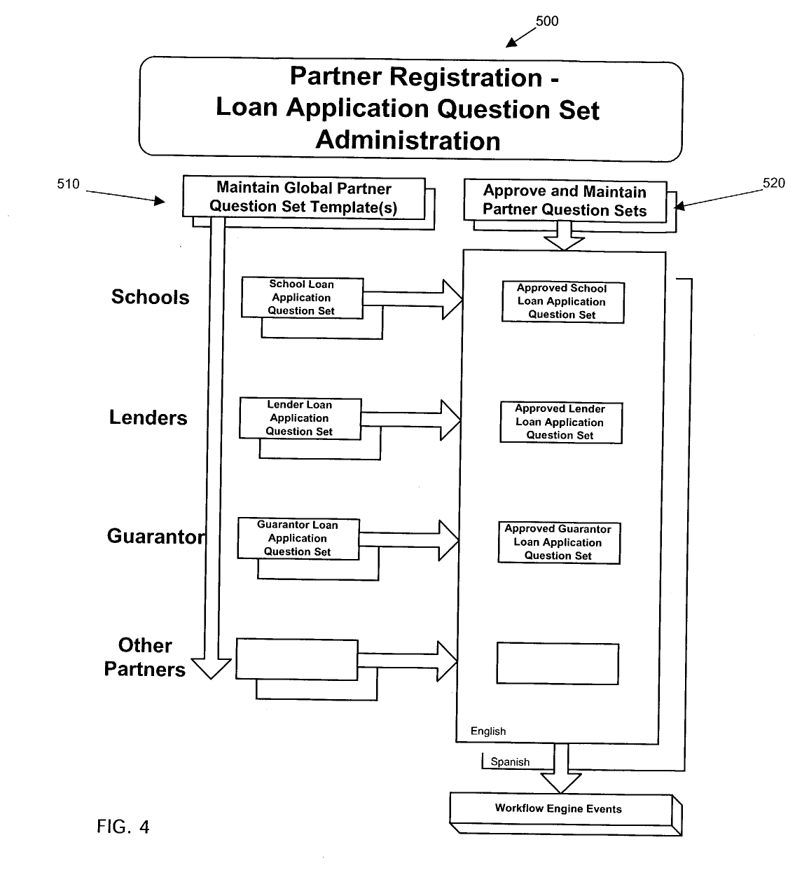

Shown in FIGS. 3 to 4 is an exemplary method for maintaining partner and applicant registration, and for dynamically generating one or more applications for completion by one or more applicants. The method may be implemented on system 10 by, for example, software. The method comprises registration process 400, and question set administration process 500.

As shown in FIG. 3, registration process 400 may be used by an applicant. According to a particularly preferred embodiment, an applicant may be a student borrower using the systems and methods disclosed to obtain student loans. As shown in FIG. 3, the borrower provides initial registration data in response to a student registration question set (step 310). Borrower registration data may include name, date of birth, social security number, alien registration number, national identification number, passport number, school name, country, state, region, province, education type, loan amount requested, enrollment period, etc.). As shown, the student registration question set may be provided in one or more languages.

Various “partners” involved with the loan application process also provide initial registration data in response to a partner registration question set (steps 315, 320, 325, 330). The various partners in a loan application process may include schools which a borrower may attend, lenders which may fund loans obtained by a borrower, guarantors which may guarantee loans obtained by a borrower, and other related partners. Partner registration data may include data as shown in APPENDIX C. Registration templates for each partner, borrower, partner type (e.g., lender, school, etc.) and borrower type (e.g., student, co-signer, etc.) are also maintained. Partner and borrower registration responses may drive the dynamic content of the question set presented to the borrower. As shown, partner registration question set may be provided in one or more languages.

Further registration templates may be maintained to be completed as additional students and/or partners utilize system 10.

As shown in FIG. 4, question set administration process 500 may be used by partners in the application process. It may be desirable to provide additional questions specific or tailored to an individual partner. For example, one partner may desire additional information not normally included in an application, whereas another partner may not desire the information requested by a first partner, and instead desire different information. For example, one partner may request information relating to a detailed break down of the intended uses of loan funds, such as amounts allocated to tuition, fees, room and board, books, etc. A second partner may request information relating to the intended uses of loan funds on a less detailed level (e.g., amounts allocated to school, living expenses, and other categories). A third partner may not wish to receive information relating to the intended uses of loan funds.

As another example, one partner lender may request information regarding equity in a borrower's home, while another partner may not request or desire such information.

As another example, some countries (such as China) may allow a lender partner to inquire as to the gender of the borrower. The lender partner may include such a question for inclusion into the loan application. In other countries (such as the United States), a lender partner may not inquire as to the gender of the borrower. Accordingly, the lender partner will not include such a question for the loan application.

According to one exemplary embodiment, one or more partners may modify a question set without the intervention of other processes of system 10. For example, a partner may directly update, change or edit one or more of the partner specific questions. The partner may customize the question sets by initiating with software, etc.

Question set administration process 500 facilitates dynamic application generation (i.e., creation of customized applications tailored to individual partners in the application process).

As shown in FIG. 4, question set administration process 500 comprises maintaining global partner question set templates (step 510), and approving and maintaining partner question sets (step 520). Maintaining global partner question set templates may include providing standard question sets which any or all partners must utilize as a baseline in order to fulfill downstream requirements of an origination and/or servicing partner. These requirements may include specific and systematic data elements required by origination and/or servicing partner data processing systems.

Question set administration process 500 also comprises approving and maintaining partner question sets (step 520). For example, individual partners can submit tailored questions which are of interest for that individual partner for inclusion into the application. Maintaining partner question sets may include providing a format in which a partner may submit their own, individual question sets for ultimately presenting to the borrower. Partner questions may need to be reviewed and/or approved to ensure that they comply with various regulations, rules, etc. Once approved, question(s) from a partner may be included in the application to be completed by the borrower.

As shown in FIG. 2, system 10 may be configured to minimize the number of unique or dynamic partner questions in second question set 250 (step 295). The unique or dynamic partner questions may be compared or otherwise reviewed with other partners unique partner questions. If it is found that one or more partner questions are not unique (i.e., other partners request the same information), such information may be included in the standard questions of second question set 250.

The systems and methods described may provide enrollment and/or credit approval questions unique to each partner for completion by a borrower. The systems and methods may be used to develop and maintain a comprehensive template of generic questions. Furthermore, each partner may utilize the dynamic application generator user interface to add and maintain unique questions, help text, attachments, workflow events and error messages designed to facilitate the loan approval process. The dynamic application generator user interface may be in the form of one or more web pages presented to a partner for input, information, data, etc. Alternatively, the user interface may utilize personal digital assistants, wireless applications, phones, voice systems, operator input, video conference connections, automatic voice response system, scanners, wireless devices, or other such user interfaces.

A partner in the process (such as for a loan process, schools, lenders, guarantors, etc.) may log on to a partner user interface and self publish “dynamic questions” for presentation to prospective students during the loan application process. Partner question sets may be utilized to qualify international student financing for both in country and U.S. based school attendance and distance learning programs. In addition, partners can define specific work flow events that trigger actions based on student responses or milestones in the loan application process.

According to a particularly preferred embodiment, the loan application system may use the NCHELP (National Council of Higher Education Loan Programs) CommonLine data format. According to alternative embodiments, a wide variety of data formats may be implemented.

According to various exemplary embodiments, the systems and methods disclosed may be configured as to allow for the various partners to exchange information relating to one or more applications with each other. For example, applications may have a variety of transaction formats which allow electronic communication between the various partners. Data may be transmitted in real time or batch XML data transports between partners based on data formats uniquely created by the systems and methods disclosed. This interconnectivity advantageously provides improved scalability and efficiency by reductions of data entry. According to other exemplary embodiments, the systems and methods support paper processes by converting dynamically generated applications into paper documents and forms which can be completed off line by the borrower.

The application systems and methods may fully implement internationalization and localization. Question sets and responses may be presented in the language of choice as specified by partners and/or borrowers. In addition, the system will automatically adjust date, time and currency data collection and corresponding forms input by the borrower.

Pick list processing may be utilized to ensure that data entered can be “mined” through an English language normalization process. Such a mining process may be used for information extraction from various forms. For example, various forms, queries and data fields may be provided in one or two or more languages. However, using information relating to the relative position of the data field, the content or response from the user may be determined or identified without the need for translation of the content.

The systems and methods disclosed advantageously facilitate various “non-standard” processes. For example, multiple languages, lenders with various criteria, partners in different countries, etc. may all use the same systems and methods.

The systems and methods disclosed advantageously facilitate customized applications providing scalability and a relatively quick roll-out period. For example, the systems and methods may be implemented with a variety of schools, lenders, etc. without reworking (e.g., re-coding) the application system.

While the embodiments illustrated in the figures and described above are presently preferred, it should be understood that these embodiments are offered by way of example only. Other embodiments may include, for example, a wide variety of ways to convey information, such as, wireless application protocol (WAP), personal digital assistant (PDA) protocols, and other presentation means. Further, while exemplary embodiments describe the invention in the context of student loan applications, the invention may extend to other loan types or a variety of other application processes, partners, process, etc. The invention is not limited to a particular embodiment, but extends to various modifications, combinations, and permutations that nevertheless fall within the scope and spirit of the appended claims.

What is claimed is:

1. A system for facilitating a loan between a borrower and a plurality of partners, the system comprising:
a processing unit;
a memory portion in communication with the processing unit having information stored therein to configure the processing unit to:
receive a plurality of partner defined question sets;
receive first data from the borrower; and
generate a loan application for the borrower;
wherein at least one partner is selected from the plurality of partners in response to the first data received from the borrower;
wherein the loan application includes at least one question from the partner defined question set of the selected partner.

2. The system of claim 1, wherein the processing unit is further configured to provide the loan application to the borrower.

3. The system of claim 2, wherein the processing unit is further configured to receive second data from the borrower in response to the loan application being provided to the borrower.

4. The system of claim 3, wherein the first and second data is presented to at least one of a lender, a guarantor and a school.

5. The system of claim 3, wherein the first data and second data comprise a completed loan application.

6. The system of claim 3, wherein the processing unit is further configured to provide a loan origination record to a loan origination partner.

7. The system of claim 1, wherein selecting a partner comprises providing a list of partners to the borrower.

8. The system of claim 7, wherein borrower selects at least one partner from the list of partners.

9. The system of claim 1, wherein the processor is configured to provide first data in at least two languages.

10. A method for generating an application for an applicant, the method comprising:
providing a first registration template for a plurality of partners;
receiving partner registration data from the plurality of partners, wherein the partner registration data comprises at least one question determined by least one partner of the plurality of partners;
providing a second registration template for completion by the applicant; and
generating a dynamic application for completion by the applicant, wherein the dynamic application further comprises the at least one partner determined question.

11. The method of claim 10, wherein the plurality of partners comprises at least one of a school, a lender and a guarantor, a credit card company, a bank and an employer.

12. A method for generating an application for an applicant, the method comprising:
receiving a plurality of partner defined question sets;
receiving first data from the applicant; and
generating an application for the applicant;
wherein at least one partner is selected from the plurality of partners in response to the first data received from the applicant;
wherein the application includes at least one question from the partner defined question set of the selected partner.

13. The system of claim 12, wherein the application is one of a student loan application, a consumer loan application, a credit card application, a school admission application, an employment application, and a loan application.

14. The system of claim 12, further comprising providing the application to the applicant.

15. The system of claim 14, further comprising receiving second data from the applicant in response to the application being provided to the applicant.

16. The system of claim 15, wherein the first and second data is presented to at least one of a school, a lender, a guarantor, a credit card company, a bank and an employer.

17. The system of claim 15, wherein the first data and second data comprise a completed application.

18. The system of claim 15, further comprising providing a loan origination record to a loan origination partner.

19. The system of claim 12, wherein selecting a partner comprises providing a list of partners to the applicant.

20. The system of claim 19, wherein the applicant selects at least one partner from the list of partners.

21. The system of claim 12, further comprising providing first data in at least two languages.
